(19) United States
(12) Patent Application Publication
(10) Pub. No.: US 2005/0039138 A1
(43) Pub. Date: Feb. 17, 2005

(54) Method and system for displaying comic books and graphic novels on all sizes of electronic display screens.

(75) Inventor: Aaron Virgil Urbina, Henderson, NV (US)

Correspondence Address: Aaron Urbina, 950 Seven Hills Dr. #128, Henderson, NV, 89052, US

(73) Assignee: Aaron Virgil Urbina, Henderson, NV (US)

(21) Appl. No.: 10/604,732

(22) Filed: Aug. 13, 2003

(51) Int. Cl. G09G 5/00; G06F 17/00

(52) U.S. Cl. 715/802; 715/800; 715/715; 715/708; 715/817; 715/818; 715/819; 715/820; 715/815; 715/829; 715/723; 715/719; 715/788; 715/508; 715/542; 715/523; 715/529

(57) ABSTRACT

A method and system for displaying comic books, and graphic novels on all sizes of electronic display screens. This method maximizes visual quality and text legibility by: displaying one panel, e.g., image at a time, and by generating and sizing the text balloons based on the text of the balloon and a font type and size selected from a group of font types and sizes that are legible for the size of the display area on which the panel and balloons are drawn.

### BACKGROUND OF INVENTION

This invention relates generally to the field of comic book and graphic novel publishing and more specifically to a method and system for displaying comic books, and graphic novels on all sizes of electronic display screens.

Comic books and graphic novels relate a narrative through a combination of text and art. Each page is typically made up of one or more panels, e.g., images. Each panel typically contains one or more text balloons, which relate the story. Typical electronic display screens have a much lower display resolution than paper printers, often by a factor of three or more. Consequently, displaying a page from a comic book on an electronic display screen reduces the visual quality and text legibility of the panels. This problem is exacerbated by the proliferation of mobile computing devices with very small display screens, such as the screen on a handheld computer, or mobile phone.

Over the past several years, a few attempts have been made at displaying comic books and graphic novels via electronic display screens. The solutions have ranged from simple to complex. The most commonly used and simplest solution is to use an image scanner to scan the pages of a comic book, and then display those scanned images on a screen, one or two pages at a time. As mentioned above, this solution suffers from the fact that typical electronic display screens have far less resolution than paper printers. Hence, the visual quality of the images suffer, and the text balloons become illegible when displayed on small screens. More complex solutions have been created by the comic book companies CrossGen and Marvel Entertainment. CrossGen uses a computer system that displays two comic book pages at a time, scaled to fit a display area on screen. The text balloons are layered on top of the panels and are magnified when the user hovers a mouse pointer over them. Marvel's system also displays two pages, but, instead of magnifying just the text balloons, Marvel's system magnifies several panels at a time. While both of these solutions are better than the simple solution mentioned above, they each contain the same fatal flaw. The flaw is that each system treats the text balloons as images. Because the text balloons are images, when the display area is reduced, the text quickly becomes illegible.

No prior art has been able to successfully maximize the visual quality and preserve the text legibility of a comic book across all sizes of electronic display screens. This is because prior art attempts to render more than one panel on screen at a time, and/or displays text balloons as images, which become illegible as they shrink to fit small display screens. Given the amount of time that previous implementers have thought about and worked on prior art solutions, it can be inferred that this present invention has not been an obvious solution.

An object of the invention is to maximize the visual quality of comic books and graphic novels displayed on electronic display screens by using the maximum available screen area to display one panel at a time.

An additional object of the invention is to maximize the legibility of comic books and graphic novels displayed on electronic display screens by generating and sizing the text balloons based on the text of the balloon and a font type and size selected from a group of font types and sizes that are legible for the size of the display area on which the panel and balloons are drawn.

A further object of the invention is to provide a way for the user to toggle the visibility of the text balloons so that the panel underneath them can be seen in totality at anytime.

An advantage of this invention is that it provides a way for comic books and graphic novels to be read on just about any electronic display screen from high-definition televisions to desktop PCs to handheld computers to mobile phones.

### SUMMARY OF INVENTION

A method and system for displaying comic books and graphic novels on all sizes of electronic display screens is provided. One embodiment of the present invention executes as a viewer program on a computer system. The viewer program displays one panel, e.g. image, at a time, on screen. The text balloons for the panel are generated and sized based on the text of the balloon and a font type and size selected from a group of font types and sizes that are legible for the size of the display area on which the panel and balloons are drawn. The user may also choose to toggle the balloon visibility, allowing the panel underneath the balloons to be visible at any time.

### BRIEF DESCRIPTION OF DRAWINGS

The drawings constitute a part of this specification and include exemplary embodiments to the invention, which may be embodied in various forms.

FIG. 1 illustrates a handheld computer with one panel and a text balloon shown on its display screen.

FIG. 2 illustrates a handheld computer with one panel and a text balloon shown on its display screen, the text balloon is drawn with a different font.

FIG. 3 illustrates a handheld computer with one panel shown on its display screen, the text balloon's visibility has been set to false.

FIG. 4 is a flow chart of operations that comprise the method.

### DETAILED DESCRIPTION

A method and system for displaying comic books and graphic novels on all sizes of electronic display screens is provided. In one embodiment, the present invention executes as a viewer program on a computer system. A flow chart and detailed description of the operations, as executed by the viewer program are given, allowing anyone with ordinary skill in the art of writing graphic oriented computer programs to implement this invention on a wide variety of computer devices with varying display screen sizes. It will be apparent, however, to one skilled in the art of writing graphic oriented computer programs, that the present invention may be implemented without these specific operations, or, may be implemented with the operations in a different order. This description is intended to illustrate the present invention and is not intended to limit the scope of the invention to the description of the operations, number of operations, or the order of the operations.

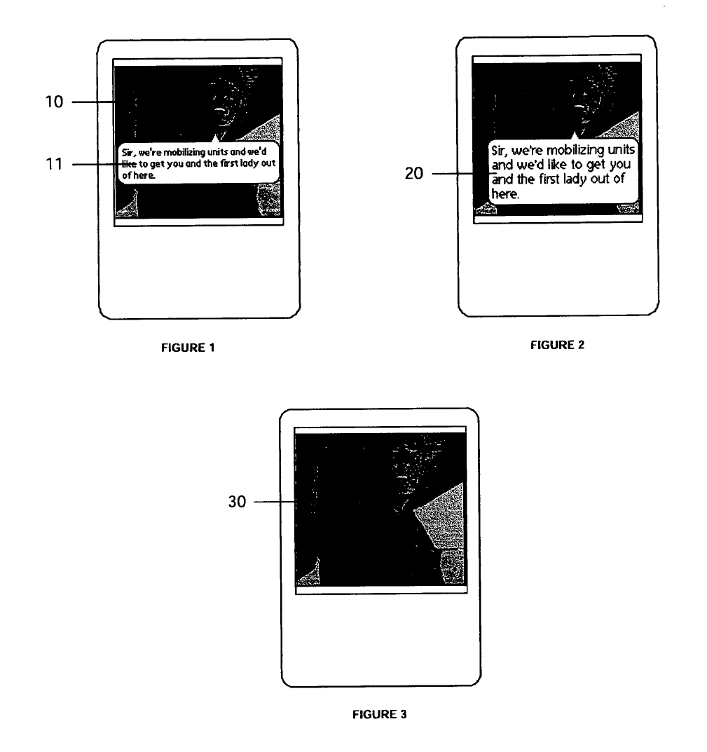

FIG. 1 illustrates the method as shown on a handheld computer. One panel is scaled to fit the display 10, and a text balloon generated and sized based on the text of the balloon and a font type and size selected from a group of font types and sizes that are legible for the size of the display area on which the panel and balloons are drawn 11.

FIG. 2 shows the said handheld computer, and said panel, this time with the text balloon re-generated and sized with a different font type and size selected from a group of font types and sizes that are legible for the size of the display area on which the panel and balloons are drawn 20.

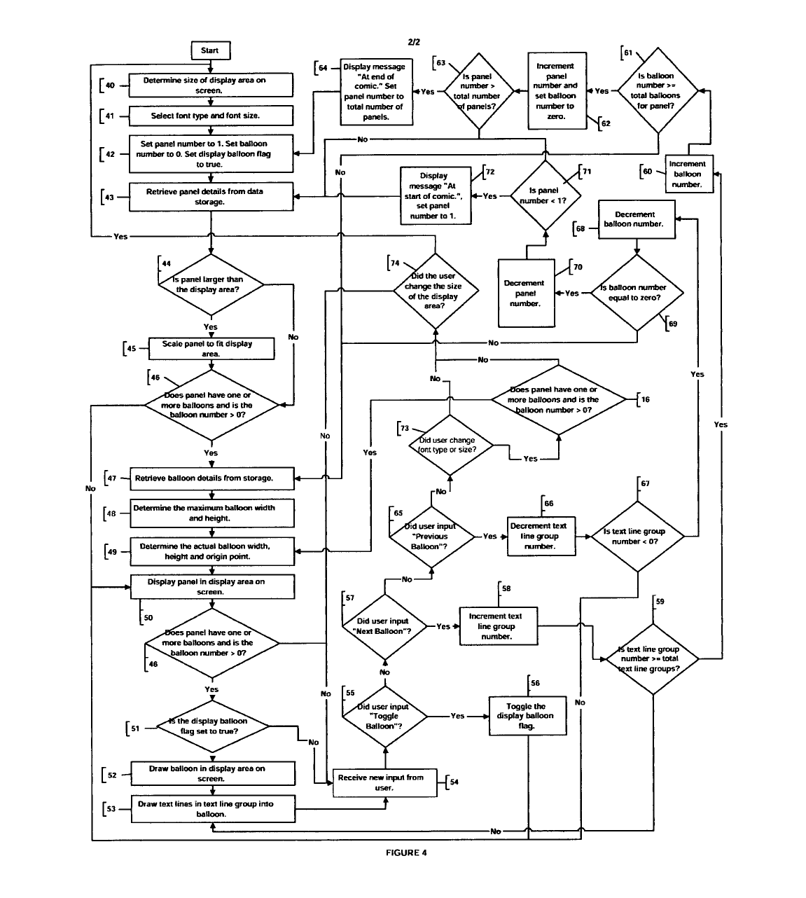

FIG. 3 shows the said handheld computer, and said panel, this time with the text balloon visibility toggled to false. Note that said panel can now be seen in its totality.

FIG. 4 is a flow chart of operations that comprise the method. Detailed descriptions of each operation are listed below.
The width and height of the on screen display area dedicated to the viewer program, hereafter referred to simply as, the display area, are determined.
The font type and font size are selected from a group consisting of font types and font sizes that are legible for the determined display area size. One way to implement this feature is to use a data structure that maps a range of display area sizes to known legible fonts for the range of sizes.
The panel, e.g., image number is set to 1, the balloon number is set to 0, the display balloon flag is set to true.
Using the current panel number as identification, the following information is retrieved from data storage, the width and height of the image, and the number of balloons the panel has.
The size of the panel is compared to the size of the display area to see if it is larger.
The panel is scaled to fit the display area. To preserve the aspect ratio of the panel, the amount of scaling is determined for each dimension of the panel, both width and height. The dimension that must scale the most is used to determine the amount of scaling applied to both dimensions. For example, if it is determined that the width must shrink by 70% to fit the new width and the height must shrink by 50% to fit the new height. The width and height are shrunk by 70% to ensure that the panel will fit the display area with no visual distortion.
A determination is made if the panel has more than 1 balloon and if the current balloon number is greater than 0.
Using the current balloon number as identification, the following balloon information is retrieved from data storage: the balloon tail origin point, the balloon tail type, the tail length x value, the tail length y value, and the text of the balloon.
The balloon maximum width and height are determined. The balloon tail type can be one of nine possible values. The values are noted as directions: “North”, “Northeast”, “East”, “Southeast”, “South”, “Southwest”, “West”, “Northwest” and the special case value of “None”, meaning the balloon does not have a tail.

If the balloon tail type is “North”, the maximum height of the balloon is calculated by subtracting the display area height from the y coordinate value of the balloon tail origin after it has been translated to the south by the tail length y value. The maximum width of the balloon is set to the width of the display area.

If the balloon type is “Northeast”, the maximum height is calculated like the “North” balloon type, and the maximum balloon width is calculated by subtracting the x coordinate of the balloon tail origin point after it has been translated to the west by the tail length x value.

If the balloon tail type is “East”, the maximum balloon width is calculated by subtracting the x coordinate of the balloon tail origin point after it has been translated to the west by the tail length x value. The maximum height of the balloon is set to the height of the display area.

If the balloon type is “Southeast”, the maximum width is calculated like the “East” balloon type, and the maximum balloon height is equal to the y coordinate of the balloon tail origin point after it has been translated to the north by the tail length y value.

If the balloon type is “South”, the maximum height is equal to the y coordinate of the balloon tail origin point after it has been translated to the north by the tail length y value. The maximum balloon width is equal to the width of the display area.

If the balloon type is “Southwest”, the maximum height is calculated like the “South” balloon type, and the maximum balloon width is equal to the width of the display area subtracted by the x coordinate of the balloon tail origin point after it has been translated to the east by the tail length x value.

If the balloon type is “West”, the maximum balloon width is equal to the width of the display area subtracted by the x coordinate of the balloon tail origin point after it has been translated to the east by the tail length x value. The maximum balloon height is equal to the height of the display area.

If the balloon type is “Northwest”, the maximum height is calculated like the “North” balloon type, and the maximum balloon width is calculated like the “West” balloon type.

If the balloon type is “None”, the maximum balloon width is calculated by subtracting the display area width from the x coordinate of the balloon tail origin point, and the maximum height is calculated by subtracting the display area height from the y coordinate of the balloon tail origin point.
The actual balloon width, height and origin point are determined. Using the metrics from the currently selected font, which indicate the width and height of each character in the font, the width of the balloon text is calculated. If the width of the balloon text exceeds the maximum balloon width, the actual balloon width is set to the maximum balloon width; otherwise the actual balloon width is recorded as the width of the balloon text. To determine the actual balloon height, using metrics from the currently selected font, the balloon text is divided into groups of text lines each of which fits into the actual balloon width. New text lines are created, on inter-word boundary characters such as spaces or hyphens. When the height of the text lines exceeds the maximum height of the balloon, a new text line group is created and the remaining balloon text is again divided into lines that fit into the actual balloon width. This process continues until enough text line groups have been created to store all lines of the balloon text. If the lines of text never exceed the maximum balloon height, only one text line group is created and the actual balloon height is set to the height of the lines in this group. The current text line group number is set to 0.

The balloon origin point is determined by the balloon type and actual balloon width and height. If the balloon type is “North” and the actual balloon width is less than the maximum balloon width, the balloon origin x coordinate is determined by subtracting from the balloon tail origin x coordinate the actual balloon width divided by 2; otherwise the balloon origin x coordinate is set to 0. The balloon origin y coordinate is equal to the balloon tail origin y coordinate translated south by the tail length y value.

If the balloon type is “Northeast” and the actual balloon width is less than the maximum balloon width, the balloon origin x coordinate is determined by subtracting from the balloon tail origin x coordinate the tail length x value and then the actual balloon width; otherwise the balloon origin x coordinate is set to 0. The balloon origin y coordinate is equal to the balloon tail origin y coordinate translated south by the tail length y value.

If the balloon type is “East” and the actual balloon height is less than the maximum balloon height, the balloon origin y coordinate is determined by subtracting from the balloon tail origin y coordinate the actual balloon height divided by 2; otherwise the balloon origin y coordinate is set to 0. If the actual balloon width is less than the maximum balloon width, the balloon origin x coordinate is determined by subtracting from the balloon tail origin x coordinate the tail x length and then the actual balloon width divided by 2; otherwise the balloon origin x coordinate is set to 0.

If the balloon type is “Southeast” and the actual balloon width is less than the maximum balloon width, the balloon origin x coordinate is determined by subtracting from the balloon tail origin x coordinate the tail length x value and then the actual balloon width; otherwise the balloon origin x coordinate is set to 0. If the actual balloon height is less than the maximum balloon height, the balloon origin y coordinate is determined by subtracting from the balloon tail origin y coordinate the tail length y value and then the actual balloon height; otherwise the balloon origin y coordinate is set to 0.

If the balloon type is “South” and the actual balloon width is less than the maximum balloon width, the balloon origin x coordinate is determined by subtracting from the balloon tail origin x coordinate the actual balloon width divided by 2; otherwise the balloon origin x coordinate is set to 0. If the actual balloon height is less than the maximum balloon height, the balloon origin y coordinate is determined by subtracting from the balloon tail origin y coordinate the tail length y value and then the actual balloon height; otherwise the balloon origin y coordinate is set to 0.

If the balloon type is “Southwest”, the balloon origin x coordinate is equal to the balloon tail origin x coordinate plus the tail length x value. If the actual balloon height is less than the maximum balloon height, the balloon origin y coordinate is determined by subtracting from the balloon tail origin y coordinate the tail length y value and then the actual balloon height; otherwise the balloon origin y coordinate is set to 0.

If the balloon type is “West”, the balloon origin x coordinate is equal to the balloon tail origin x coordinate plus the tail length x value. If the actual balloon height is less than the maximum balloon height, the balloon origin y coordinate is determined by subtracting from the balloon tail origin y coordinate the tail length y value and then the actual balloon height divided by 2; otherwise the balloon origin y coordinate is set to 0.

If the balloon type is “Northwest”, the balloon origin x coordinate is equal to the balloon tail origin x coordinate plus the tail length x value. The balloon origin y coordinate is equal to the balloon tail origin y coordinate plus the tail length y value.

If the balloon type is “None”, the balloon origin x coordinate is equal to the balloon tail origin x coordinate. The balloon origin y coordinate is equal to the balloon tail origin y coordinate.
The panel is shown in the display area on screen.
A determination is made if the display balloon flag is set to true or not.
The balloon is drawn on top of the panel in the display area on screen. The balloon origin point, balloon tail type, tail length and balloon width and height are used to accomplish the drawing of the balloon shape.
The current text line group number is used to retrieve the text lines from data storage that will be displayed in the balloon. The text is drawn on top of the balloon shape.
Wait for new input from the user.
A determination is made whether or not the user inputted the “Toggle Balloon” command.
Toggle the display balloon flag, if the display balloon flag is set to true, it is changed to false, if the flag is set to false, it is set to true.
A determination is made whether or not the user inputted the “Next” command.
The current text line group number is incremented.
A determination is made to see if the current text line group number is greater than or equal to the total number of text line groups.
The current balloon number is incremented.
A determination is made to see if the current balloon number is greater than the total number of balloons for the current panel.
The current panel number is incremented and the current balloon number is set to 0.

A determination is made to see if the current panel number is greater than the total number of panels for this comic or graphic novel.
The current panel number is set to the total number of panels. A message “At end of comic.” Message is displayed.
A determination is made whether or not the user inputted the “Previous” command.
The current text line group number is decremented.
A determination is made to see if the current text line group number is less than 0.
The current balloon number is decremented.
A determination is made to see if the current balloon number is equal to 0.
The current panel number is decremented.
A determination is made to see if the current image number is equal to 0.
The current panel number is set to 1. A message “At start of comic.” is displayed.
A determination is made whether or not the user has selected a new font from a group consisting of legible fonts for the given display area size.
A determination is made whether or not the user has changed the size of the display area for the viewer program on screen.
Accordingly, upon implementation of the operations illustrated in FIG. 4 and described within this document, the visual quality of each panel of a comic book or graphic novel will be maximized by devoting the maximum available screen area to the panel at a time. Furthermore the invention has additional advantages in that:

It maximizes the legibility of the balloon text by generating and sizing the text balloons based on the text of the balloon and a font type and size selected from a group of font types and sizes that are legible for the size of the display area on which the panel and balloons are drawn.

It provides a way for the user to toggle the visibility of the text balloons so that the panel underneath them can be seen in totality at anytime.

It is the first successful solution that allows comic books and graphic novels to be read on all sizes of electronic display screens including the screens of desktop PCs, handheld computers and mobile phones.

While the present invention has been described with reference to a particular embodiment, it is understood that the disclosure has been made for purpose of illustrating the invention by way of example and is not intended to limit the scope of the attached claims. It is understood that operations may be arranged in different ways and that equivalent operations can be substituted for those described here. These changes and substitutions are not intended to depart from the scope and the spirit of the present invention.

1. A method in a computer system for displaying comic books, and graphic novels on all sizes of electronic display screens, comprising the steps of:
displaying one panel, e.g., image at a time;
generating text balloons based on the text of the balloon;
sizing the text balloons based on the text of the balloon and a predetermined font type and font size selected from a group consisting of font types and font sizes that are legible for the size of the display area on which the panel and balloons are drawn.

2. The method of claim 1 wherein said panel is scaled to fit the size of the display area on the screen.

3. The method of claim 1 wherein the position and sizing of said text balloons is further determined by the size of the display area on screen, a balloon tail type, and a balloon tail origin point.

4. The method of claim 1 wherein the visibility of said text balloons can be toggled.

5. The method of claim 1 wherein only one of the said text balloons is shown on screen at a time.
